(19) United States
(12) Patent Application Publication
(10) Pub. No.: US 2018/0250862 A1
(43) Pub. Date: Sep. 6, 2018

(54) CONVEYER DEVICE AND METHOD FOR PRODUCING FILM

(71) Applicant: Sumitomo Chemical Company, Limited, Tokyo (JP)

(72) Inventors: Atsuhiro TAKATA, Niihama-shi (JP); Hirohiko HASEGAWA, Niihama-shi (JP); Takuya AKIYAMA, Niihama-shi (JP)

(21) Appl. No.: 15/909,970

(22) Filed: Mar. 1, 2018

(30) Foreign Application Priority Data
Mar. 3, 2017 (JP) 2017-041089

(51) Int. Cl. B29C 47/00; B29C 47/34; B29C 47/88; H01M 2/14

(52) U.S. Cl. CPC B29C 47/0057; B29C 47/34; B29C 47/8845; B29C 47/906; H01M 2/145; B29C 47/8875; B29C 47/0021

(57) ABSTRACT

To provide a conveyer device that can prevent a sheet-shaped base material comprising a fluid plasticizer from slipping in the lengthwise direction of a roller and thereby prevent a flaw such as a wrinkle in the sheet-shaped base material comprising a fluid plasticizer, the sheet-shaped base material extending in a longitudinal direction and having a width defined in a direction orthogonal to the longitudinal direction, a conveyer device (1) includes a plurality of rollers (R1 and 102), at least one roller (R1) of the plurality of rollers (R1 and 102) having a length not smaller than the width of the sheet-shaped base material (S1), the plurality of rollers (R1 and 102) having a slipping preventing mechanism configured to prevent the sheet-shaped base material (S1) from slipping on the at least one roller (R1).

This Nonprovisional application claims priority under 35 U.S.C. § 119 on Patent Application No. 2017-041089 filed in Japan on Mar. 3, 2017, the entire contents of which are hereby incorporated by reference.

### TECHNICAL FIELD

The present invention relates to a conveyer device and a method for producing a film.

### BACKGROUND ART

Recent years have seen, in the field of separators for lithium-ion batteries, great attention to a wet method for producing a separator from a polyolefin and a fluid plasticizer such as a liquid paraffin for an increased processability during the production process and improved properties.

### CITATION LIST

### Patent Literature

[Patent Literature 1]

Japanese Patent Application Publication, Tokukaihei, No. 11-60789 (Publication Date: Mar. 5, 1999)

[Patent Literature 2]

Japanese Patent Application Publication, Tokukai, No. 2000-248088 (Publication Date: Sep. 12, 2000)

### SUMMARY OF INVENTION

### Technical Problem

A wet process of producing a separator necessarily involves conveying, with use of a plurality of rollers, a sheet-shaped base material containing a fluid plasticizer such as a liquid paraffin.

FIG. 9 is a diagram illustrating individual steps of a wet process for producing a separator.

As illustrated in FIG. 9, a kneading-forming-cooling step involves (i) feeding, into a twin-screw extruder 100, a composition containing a polyolefin and a fluid plasticizer, (ii) kneading the composition, (iii) extruding, from the twin-screw extruder 100, a sheet-shaped base material S1 (film), and (iv) conveying the sheet-shaped base material S1 (containing a fluid plasticizer), extruded and having a predetermined shape, with use of, for example, a cooling roller 101 and conveyance rollers 102 for a subsequent step while the sheet-shaped base material S1 containing a fluid plasticizer is being cooled.

A wet process of producing a separator further includes a step of longitudinally stretching the sheet-shaped base material containing a fluid plasticizer (that is, a step of stretching the sheet-shaped base material in its lengthwise direction), a step of laterally stretching the sheet-shaped base material containing a fluid plasticizer (that is, a step of stretching the sheet-shaped base material in its widthwise direction), a step of winding up the sheet-shaped base material (containing a fluid plasticizer) stretched in two axis directions, and a step of cleaning the sheet-shaped base material (containing a fluid plasticizer) stretched in two axis directions for removal of the fluid plasticizer from the sheet-shaped base material containing a fluid plasticizer (that is, a step of extracting a fluid plasticizer). These steps also involve use of rollers such as conveyance rollers. The step of winding up the sheet-shaped base material (containing a fluid plasticizer) stretched in two axis directions may be omitted.

However, when a sheet-shaped base material containing a fluid plasticizer is conveyed with use of various rollers (such as the cooling roller 101 and the conveyance rollers 102) each having a smooth curved surface, the fluid plasticizer contained in the sheet-shaped base material causes the issue discussed below.

FIG. 10 is a diagram illustrating an issue involved in a case where a sheet-shaped base material S1 (film) containing a fluid plasticizer is conveyed with use of a roller 200 having a smooth curved surface as with, for example, the cooling roller 101 and the conveyance rollers 102.

As illustrated in FIG. 10, a fluid plasticizer layer is easily formed from a fluid plasticizer component transferred from the sheet-shaped base material S1 (which contains a fluid plasticizer) on the smooth curved surface of the roller 200 with which curved surface the sheet-shaped base material S1 containing a fluid plasticizer comes into contact. This causes the sheet-shaped base material S1 containing a fluid plasticizer to slip on the roller 200, thereby causing the sheet-shaped base material S1 to meander in the lengthwise direction of the roller (that is, the left-right direction of FIG. 10) or failing to apply a sufficient tension to the sheet-shaped base material S1. The above configuration consequently leads to a flaw in, for example, the conveyance of the sheet-shaped base material S1 containing a fluid plasticizer.

A sheet-shaped base material S1 containing a fluid plasticizer meanders in the lengthwise direction of the roller 200 as above presumably for the following reason among others: A sheet-shaped base material S1 containing a fluid plasticizer may have an uneven thickness due to, for example, non-uniform stretching caused by a slight deformation of a discharge opening of an extruder for forming a sheet-shaped base material S1 (containing a fluid plasticizer) or an uneven temperature during the stretching step. The sheet-shaped base material S1 containing a fluid plasticizer may be inclined as a result.

The present invention has been accomplished in view of the above issue. It is an object of the present invention to provide a conveyer device and a method for producing a film both of which prevent a base material (film) containing a fluid plasticizer from slipping on a roller and thereby prevent a flaw in, for example, the conveyance of the base material (film).

### Solution to Problem

In order to attain the above object, a conveyer device in accordance with an embodiment of the present invention is a conveyer device, comprising: a plurality of rollers configured to convey a film comprising a fluid plasticizer, the film extending in a longitudinal direction and having a width defined in a direction orthogonal to the longitudinal direction, at least one roller of the plurality of rollers having a length not smaller than the width of the film, the plurality of rollers having a slipping preventing mechanism configured to prevent the film from slipping on the at least one roller.

The above configuration allows the conveyer device to prevent a film comprising a fluid plasticizer from slipping on a roller and thereby prevent a flaw in, for example, the conveyance of the film.

In order to attain the above object, a method in accordance with an embodiment of the present invention for producing a film is a method for producing a film, the method comprising a step of: conveying, with use of a plurality of rollers, a film comprising a fluid plasticizer, the film extending in a longitudinal direction and having a width defined in a direction orthogonal to the longitudinal direction, at least one roller of the plurality of rollers having a length not smaller than the width of the film, and the plurality of rollers having a slipping preventing mechanism configured to prevent the film from slipping on the at least one roller.

The above configuration allows the method to prevent a film comprising a fluid plasticizer from slipping on a roller and thereby prevent a flaw in, for example, the conveyance of the film.

### Advantageous Effects of Invention

An aspect of the present invention makes it possible to prevent a film comprising a fluid plasticizer from slipping on a roller and thereby prevent a flaw in, for example, the conveyance of the film.

### BRIEF DESCRIPTION OF DRAWINGS

(a) of FIG. 1 is a diagram schematically illustrating the configuration of a conveyer device configured to convey, during a kneading-forming-cooling step, a sheet-shaped base material containing a fluid plasticizer, and (b) of FIG. 1 is a diagram illustrating a roller included in the conveyer device.

FIG. 2 provides diagrams each illustrating another example of how the plurality of rollers included in the conveyer device in FIG. 1 are arranged.

FIG. 3 provides diagrams each illustrating an example of how a squeeze roller is provided that is in contact with a porous material on a roller which may be included in the conveyer device in FIG. 1.

FIG. 4 is a diagram schematically illustrating the configuration of a conveyer device including (i) nip rollers for holding and conveying a sheet-shaped base material containing a fluid plasticizer, (ii) stretching rollers for stretching the sheet-shaped base material containing a fluid plasticizer, and (iii) a pressing roller.

FIG. 5 provides diagrams schematically illustrating the configuration of a roller having a curved surface with asperities.

FIG. 6 configuration of a conveyer device including a roller that is provided with the porous material covering the entire exposed surface of the roller and that is used as a touch roller for a winding section configured to wind up a sheet-shaped base material containing a fluid plasticizer.

(a) of FIG. 7 is a diagram schematically illustrating the configuration of a conveyer device including a plurality of conveyance rollers each having a smooth curved surface that is not provided with the porous material, at least one of the conveyance rollers having a holding angle of not less than 150 degrees and not more than 270 degrees with respect to the sheet-shaped base material containing a fluid plasticizer, and (b) of FIG. 7 is a diagram illustrating a conveyance roller having a holding angle of not less than 150 degrees and not more than 270 degrees with respect to the sheet-shaped base material containing a fluid plasticizer.

FIG. 8 is a diagram schematically illustrating the configuration of a conveyer device including a plurality of conveyance rollers each having a smooth curved surface that is not provided with the porous material, the shortest distance between the surface of a conveyance roller and the surface of an adjacent conveyance roller being not less than 1 cm and not more than 30 cm.

FIG. 9 is a diagram illustrating individual steps of a wet process for producing a separator.

FIG. 10 is a diagram illustrating an issue involved in a case where a sheet-shaped base material containing a fluid plasticizer is conveyed with use of only a roller having a smooth curved surface.

### DESCRIPTION OF EMBODIMENTS

The following description will discuss embodiments of the present invention with reference to FIGS. 1 to 8. In the description below, a member of an embodiment that is identical in function to a member described for another embodiment may be assigned the same reference sign and may not be described again for convenience.

### Embodiment 1

(a) of FIG. 1 is a diagram schematically illustrating the configuration of a conveyer device 1 configured to convey, during a kneading-forming-cooling step, a sheet-shaped base material S1 containing a fluid plasticizer. (b) of FIG. 1 is a diagram illustrating a roller R1 included in the conveyer device 1. The description below may refer to a sheet-shaped base material S1 containing a fluid plasticizer simply as “sheet-shaped base material S1.”

As illustrated in (a) of FIG. 1, a wet process of producing a separator involves a conveyer device 1 including a plurality of rollers for conveyance of a sheet-shaped base material S1. The present embodiment is an example case in which a conveyer device 1 is used during a kneading-forming-cooling step of the wet process of producing a separator. The present invention is, however, not limited to such a step.

Examples of the fluid plasticizer include (i) a saturated hydrocarbon such as liquid paraffin, (ii) a phthalate ester such as dibutyl phthalate, bis(2-ethylhexyl) phthalate, dioctyl phthalate, and dinonyl phthalate, and (iii) an unsaturated higher alcohol such as oleyl alcohol.

The present embodiment is an example case in which a composition is supplied to a twin-screw extruder 100 which composition has been prepared by adding 80% by weight of liquid paraffin to 20% by weight of a polyethylene mixture prepared by mixing (i) 5% by weight to 30% by weight of an ultrahigh molecular weight polyethylene (UHMwPE) having a weight-average molecular weight (Mw) of 1,000,000 to 3,000,000 with (ii) 95% by weight to 70% by weight of a polyethylene having a weight-average molecular weight (Mw) of 300,000 to 800,000. The composition ratio of the components of the polyethylene mixture and that of the polyethylene and the liquid paraffin are not limited to the above examples.

The composition of the polyethylene mixture and the liquid paraffin is kneaded in the twin-screw extruder 100 sufficiently and is then extruded into the form of a sheet-shaped base material S1 containing a fluid plasticizer (liquid paraffin). The sheet-shaped base material S1 extruded from the twin-screw extruder 100 is shaped to have a length (corresponding to the conveyance direction) larger than its width.

Then, the sheet-shaped base material S1 is, while being cooled, conveyed for a subsequent step with use of a plurality of rollers 101, R1, and 102 included in the conveyer device 1.

As illustrated in (b) of FIG. 1, the roller R1 included in the conveyer device 1 has a surface covered by a porous material having a predetermined thickness. (b) of FIG. 1 shows an arrow indicative of the direction in which the sheet-shaped base material S1 is conveyed and also indicative of the longitudinal direction of the sheet-shaped base material S1.

The roller R1 included in the conveyer device 1 preferably has a length (that is, the dimension in the left-right direction of FIG. 1) not smaller than a width of the sheet-shaped base material S1 which width is in the direction orthogonal to the longitudinal direction of the sheet-shaped base material S1.

The porous material is preferably one selected from the group consisting of rigid urethane, flexible urethane, urethane rubber, urethane elastomer, ethylene propylene rubber, and ethylene-propylene-diene rubber.

The porous material may preferably have a thickness of not less than 5 mm and not more than 1 cm.

The porous material may cover at least a portion of the curved surface of the roller R1. The present embodiment is configured such that the porous material is flexible urethane, has a thickness of 7 mm, and is provided on (i) the entire curved surface of the roller R1, with which curved surface the sheet-shaped base material S1 comes into contact, and (ii) the side surfaces of the roller R1, with which side surfaces the sheet-shaped base material S1 does not come into contact. The present invention is, however, not limited to such a configuration, and may be configured such that the porous material is provided on at least a portion of the curved surface of the roller R1, with which curved surface the sheet-shaped base material S1 comes into contact.

As illustrated in (b) of FIG. 1, since the curved surface of the roller R1, with which curved surface the sheet-shaped base material S1 comes into contact, is covered by the porous material, a fluid plasticizer layer containing a fluid plasticizer as a main component is not easily formed on the curved surface, and the sheet-shaped base material S1 does not easily slip on the roller R1. The above configuration can, in other words, prevent the sheet-shaped base material S1 from slipping in the lengthwise direction of the roller R1 (that is, the left-right direction in FIG. 1) and meandering in consequence. The above configuration can thereby prevent a defect such as a wrinkle in the sheet-shaped base material S1. The above configuration can prevent the sheet-shaped base material S1 from slipping in the conveyance direction, and thus allows the sheet-shaped base material S1 to be conveyed while a sufficient tension is being applied to the sheet-shaped base material S1.

The conveyer device 1 includes a cooling roller 101 and conveyance rollers 102, each of which has a curved surface with which curved surface the sheet-shaped base material S1 comes into contact. The curved surface is smooth and is not provided with the porous material.

The present embodiment is configured such that the cooling roller 101, with which the sheet-shaped base material S1 extruded from the twin-screw extruder 100 comes into contact first, has a curved surface that is not provided with the porous material. This is in view of the following: A sheet-shaped base material S1 in the molten state will have a portion shaped by the porous material; the heat of the sheet-shaped base material S1 will degrade the porous material; and the porous material, which has a low thermal conductivity, is not suitable for cooling of the sheet-shaped base material S1.

The present invention is, however, not limited to such a configuration, and may be configured such that in a case where the conveyer device 1 includes a sufficient cooling means between the twin-screw extruder 100 and a roller with which the sheet-shaped base material S1 extruded from the twin-screw extruder 100 comes into contact first, the porous material is provided on the curved surface of the roller with which the sheet-shaped base material S1 extruded from the twin-screw extruder 100 comes into contact first.

The present embodiment described here is an example case in which the porous material is provided on the surface of the roller R1, which is one of a plurality of rollers included in the conveyer device 1. The present invention is, however, not limited to such a configuration, and may be configured such that the porous material is, according to need, provided on the respective surfaces of two or more rollers or all the rollers for an increased effect.

The present embodiment described here is an example case in which the porous material covers the entire exposed surface of the roller R1 included in the conveyer device 1. The present invention is, however, not limited to such a configuration, and may be configured such that the porous material covers a portion of the curved surface of the roller R1 included in the conveyer device 1.

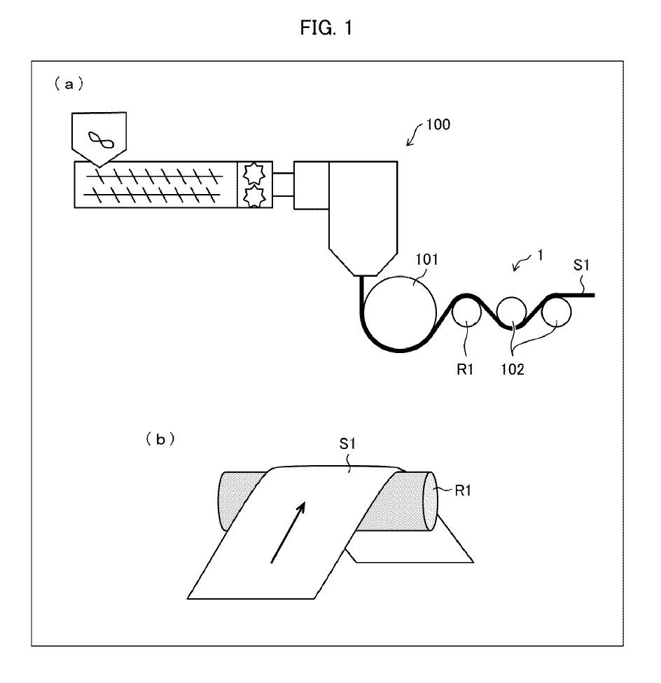

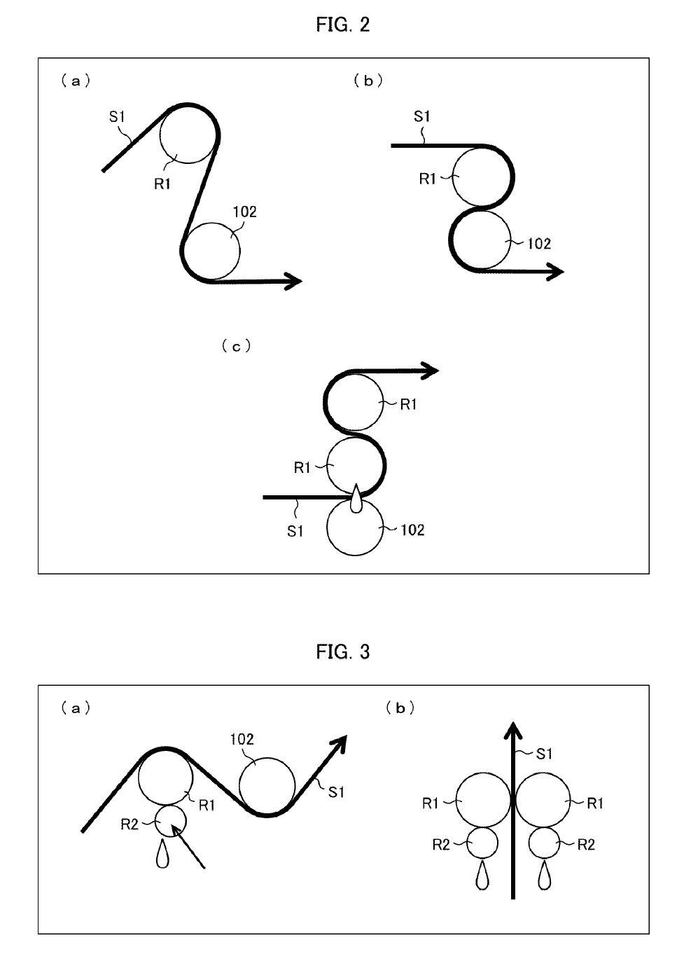

FIG. 1 illustrates an example case in which the conveyer device 1 includes a plurality of rollers 101, R1, and 102 arranged in the left-right direction of FIG. 1 such that the roller 101 and the roller R1 are separated from each other by a predetermined distance, the roller R1 and the rollers 102 are separated from each other by a predetermined distance, and the rollers 102 adjacent to each other are separated from each other by a predetermined distance. The present invention is, however, not limited to such a configuration, and may be configured, for instance, such that the plurality of rollers R1 and 102, positioned downstream of the cooling roller 101, are arranged as illustrated in FIG. 2 referred to below.

FIG. 2 provides diagrams each illustrating another example of how the plurality of rollers R1 and 102 included in the conveyer device 1 in FIG. 1 are arranged.

(a) of FIG. 2 is a diagram illustrating a sheet-shaped base material S1 being conveyed with use of (i) a roller R1 positioned above in the diagram and having an exposed surface (surface) provided with the porous material and (ii) a conveyance roller 102 positioned below in the diagram and having a smooth curved surface not provided with the porous material.

(b) of FIG. 2 is a diagram illustrating a case where a roller R1 and a conveyance roller 102 are arranged such that a sheet-shaped base material S1 on the porous material covering the surface of the roller R1 comes into contact with the curved surface of the conveyance roller 102. The roller R1 and the conveyance roller 102 arranged as such can squeeze the fluid plasticizer component from the sheet-shaped base material S1 while the sheet-shaped base material S1 is passing between the roller R1 and the conveyance roller 102. The porous material on the roller R1 and the conveyance roller 102 are provided so that the porous material and the curved surface of the conveyance roller 102 sandwich the sheet-shaped base material S1. In other words, the porous material on the roller R1 is in contact with the curved surface of the conveyance roller 102 via the sheet-shaped base material S1. This makes it possible to squeeze a fluid plasticizer component also from the porous material on the roller R1 which porous material has absorbed the fluid plasticizer component.

(c) of FIG. 2 is a diagram illustrating a case where two adjacent rollers R1 and a single conveyance roller 102 are arranged such that (i) the respective porous materials of the two rollers R1 sandwich a sheet-shaped base material S1 and that (ii) the porous material on one of the two adjacent rollers R1 and the curved surface of the conveyance roller 102 sandwich a sheet-shaped base material S1. In other words, (c) of FIG. 2 illustrates a case where two rollers R1 and a single conveyance roller 102 are arranged such that (i) the respective porous materials on the two adjacent roller R1 are in contact with each other via the sheet-shaped base material S1 and that (ii) the porous material on one of the adjacent rollers R1 and the curved surface of the conveyance roller 102 are in contact with each other via the sheet-shaped base material S1.

The above configuration makes it possible to squeeze the fluid plasticizer component from the sheet-shaped base material S1 while the sheet-shaped base material S1 is passing between the roller R1 and the conveyance roller 102. The porous material on one of the two adjacent rollers R1 and the curved surface of the conveyance roller 102 sandwich a sheet-shaped base material S1. In other words, the porous material on the roller R1 and the curved surface of the conveyance roller 102 are in contact with each other via the sheet-shaped base material S1. This makes it possible to squeeze a fluid plasticizer component from the porous material on the roller R1 which porous material has absorbed the fluid plasticizer component.

The above configuration makes it possible to squeeze the fluid plasticizer component from the sheet-shaped base material S1 also while the sheet-shaped base material S1 is passing between the two rollers R1. The respective porous materials on the two rollers R1 sandwich the sheet-shaped base material S1. In other words, the respective porous materials on the two rollers R1 are in contact with each other via the sheet-shaped base material S1. This makes it also possible to squeeze a fluid plasticizer component from the porous material on each roller R1 which porous material has absorbed the fluid plasticizer component.

As described above, (b) and (c) of FIG. 2 each illustrate an example case in which the contact member that sandwiches a sheet-shaped base material S1 with the porous material on a roller R1 is, as a contact member with which the porous material on the roller R1 is in contact via the sheet-shaped base material S1, (i) a conveyance roller 102 as a roller for conveying a sheet-shaped base material S1 or (ii) a roller R1. The present invention is, however, not limited to such a configuration, and may be configured such that as illustrated in FIG. 3 referred to below, the conveyer device 1 includes a squeeze roller R2 as a separate contact member that does not serve to convey a sheet-shaped base material S1 and that is in direct contact with the porous material on the roller R1. The present embodiment may include a removing mechanism configured to remove the fluid plasticizer component adhering to the roller R1.

FIG. 3 provides diagrams each illustrating an example of how a squeeze roller R2 is provided that is in contact with the porous material on a roller R1 which may be included in the conveyer device 1 in FIG. 1.

(a) of FIG. 3 is a diagram illustrating an example arrangement of (i) a conveyance roller 102, (ii) a roller R1, and (iii) a squeeze roller R2 in contact with the porous material on the roller R1. This arrangement allows the squeeze roller R2, which is in contact with the porous material on the roller R1, to squeeze, from the porous material on the roller R1, the fluid plasticizer component that the porous material on the roller R1 has absorbed.

(b) of FIG. 3 is a diagram illustrating an example arrangement of (i) two rollers R1 and (ii) two squeeze rollers R2 in contact with the respective porous materials on the two rollers R1. This arrangement causes the porous material on each roller R1 which porous material has absorbed a fluid plasticizer component to be in contact with the corresponding squeeze roller R2. This makes it possible to squeeze the fluid plasticizer component from each porous material. The above arrangement further causes the respective porous materials on the two rollers R1 to sandwich a sheet-shaped base material S1. In other words, the respective porous materials on the two roller R1 are in contact with each other via the sheet-shaped base material S1. This also makes it possible to squeeze the fluid plasticizer component from each porous material.

In a case where as illustrated in (b) and (c) of FIG. 2 and (a) and (b) of FIG. 3, a roller R1 is in contact with a squeeze roller R2 or a roller R1 and a conveyance roller 102 sandwich a sheet-shaped base material S1, in other words, in a case where the roller R1 is in contact with the squeeze roller R2 or the conveyance roller 102 directly or via the sheet-shaped base material S1, driving such a roller involves a heavier load. If such a roller R1 is a free roller, the roller R1 will not be rotated unless a large tension is applied to the sheet-shaped base material S1. The roller R1 may thus preferably include a driving mechanism that is a roller configured to be driven to rotate. In a case where a roller R1 is to be driven to rotate as such, the conveyer device 1 includes at least a driving circuit (not shown) and a rotation driving mechanism (not shown) for driving the roller R1 to rotate. A removing mechanism for removing the fluid plasticizer adhering to the roller R1 is, other than a contact member such as the squeeze roller R2, a blade or an air knife. Using a blade or an air knife instead of the contact member can achieve a function equivalent to that achieved by a contact member such as the squeeze roller R2.

The present embodiment described here is an example case in which a conveyer device 1 configured to convey a sheet-shaped base material S1 is used during the kneading-forming-cooling step as described above. The present invention is, however, not limited to such a configuration, and may be configured such that the conveyer device 1 configured to convey a sheet-shaped base material S1 is used during any of a stretching step, a winding step, and a cleaning/removing step of cleaning a sheet-shaped base material S1 for removal of a fluid plasticizer from the sheet-shaped base material S1.

The present embodiment is a case where a slipping preventing mechanism for preventing the sheet-shaped base material S1 from slipping on a roller R1 is a porous material provided on the curved surface of the roller R1 with which curved surface the sheet-shaped base material S1 comes into contact.

### Embodiment 2

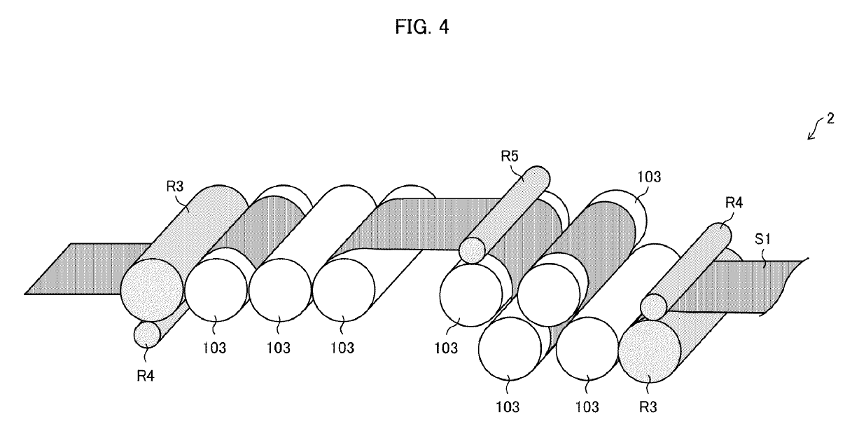

The following description will discuss Embodiment 2 of the present invention with reference to FIG. 4. The present embodiment described here differs from Embodiment 1 in that the present embodiment includes a conveyer device 2 used during a longitudinal stretching step of longitudinally stretching a sheet-shaped base material S1 (that is, a step of stretching a sheet-shaped base material in its lengthwise direction). The present embodiment is otherwise as described for Embodiment 1. A member of the present embodiment that is identical in function to a member illustrated in the drawings referred to for Embodiment 1 is assigned the same reference sign and is not described again for convenience.

FIG. 4 is a diagram schematically illustrating the configuration of a conveyer device 2 including (i) nip rollers R3 and R4 for holding and conveying a sheet-shaped base material S1, (ii) stretching rollers 103 for stretching the sheet-shaped base material S1, and (iii) a pressing roller R5.

The nip rollers R3 and R4 for holding and conveying a sheet-shaped base material S1 each have a curved surface at least a portion of which is covered by the porous material as with a roller R1 of Embodiment 1 described above. The stretching rollers 103 for stretching a sheet-shaped base material S1 each have a curved surface with which curved surface the sheet-shaped base material S1 comes into contact. The curved surface is smooth and is not provided with the porous material. The stretching rollers 103 are each configured such that its surface temperature may be set at a predetermined temperature in order to be capable of stretching the sheet-shaped base material S1 at a temperature raised to the predetermined temperature.

The pressing roller R5 is provided adjacently to a stretching roller 103 and serves to press the sheet-shaped base material S1 on the stretching rollers 103. The pressing roller R5, as with a roller R1 of Embodiment 1 described above, has a curved surface at least a portion of which is covered by the porous material.

The present embodiment is configured such that the porous material is provided on the respective surfaces of the nip rollers R3 and R4 and the pressing roller R5 and is not provided on the respective surfaces of the stretching rollers 103. This is because providing the porous material on the respective surfaces of the stretching rollers 103 as main rollers for the stretching step may result in such problems as (i) deformation of a roller due to, for example, a high temperature and/or a high tension or (ii) defective thermal conduction (as the stretching rollers 103 are heating rollers).

As illustrated in FIG. 4, since the porous material is provided on the respective surfaces of the nip rollers R3 and R4, a fluid plasticizer layer containing a fluid plasticizer as a main component is not easily formed on those surfaces, and the sheet-shaped base material S1 does not easily slip on the nip rollers R3 and R4 in the lengthwise direction or in the conveyance direction. The above configuration can thereby apply a sufficient tension to the sheet-shaped base material S1 and prevent a defect such as a wrinkle in the sheet-shaped base material S1.

The present embodiment described here is an example case in which the porous material is provided on each of the nip rollers R3 and R4. The porous material may alternatively cover at least a portion of the curved surface of each nip roller R3 or at least a portion of the curved surface of each nip roller R4. The present embodiment may include a removing mechanism configured to remove the fluid plasticizer adhering to at least one of the following rollers: the nip rollers R3 and R4 and the pressing roller R5.

### Embodiment 3

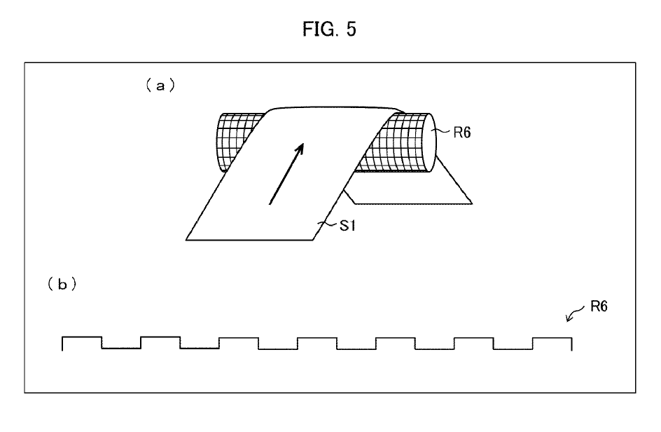

The following description will discuss Embodiment 3 of the present invention with reference to FIG. 5. The present embodiment differs from Embodiments 1 and 2 in that the present embodiment includes a roller R6 having a surface with asperities. The present embodiment is otherwise as described for Embodiments 1 and 2. A member of the present embodiment that is identical in function to a member illustrated in the drawings referred to for Embodiment 1 or 2 is assigned the same reference sign and is not described again for convenience.

FIG. 5 provides diagrams schematically illustrating the configuration of a roller R6 having a curved surface with asperities.

(a) of FIG. 5 is a diagram illustrating a sheet-shaped base material S1 being conveyed with use of the roller R6, which has a curved surface with asperities. (b) of FIG. 5 is a diagram illustrating the asperities on the curved surface of the roller R6.

Embodiments 1 and 2 described above are each a case where the porous material provided on at least a portion of the curved surface of a roller R1 acts as a slipping preventing mechanism for preventing the sheet-shaped base material S1 from slipping in the lengthwise direction of the roller R1. The present embodiment is, in contrast, a case where the asperities on at least a portion of the curved surface of the roller R6 act as a slipping preventing mechanism for preventing the sheet-shaped base material S1 from slipping in the lengthwise direction of the roller R6.

The curved surface of the roller R6, with which curved surface the sheet-shaped base material S1 comes into contact, has asperities. This can prevent the sheet-shaped base material S1 from slipping on the roller R6 in the lengthwise direction of the roller R6 (that is, in the left-right direction of FIG. 5) or in the conveyance direction. The above configuration can, in other words, prevent the sheet-shaped base material S1 from slipping or meandering in the lengthwise direction of the roller R6, and can thereby prevent a defect such as a wrinkle in the sheet-shaped base material S1. The above configuration can prevent the sheet-shaped base material S1 from slipping in the conveyance direction, and thus allows the sheet-shaped base material S1 to be conveyed while a sufficient tension is being applied to the sheet-shaped base material S1.

The present embodiment described here is an example case in which the roller R6 has asperities on all the surfaces other than the side surfaces. The roller R6 may alternatively have asperities on only a portion of the curved surface. The present embodiment may include a removing mechanism configured to remove the fluid plasticizer adhering to the roller R6.

### Embodiment 4

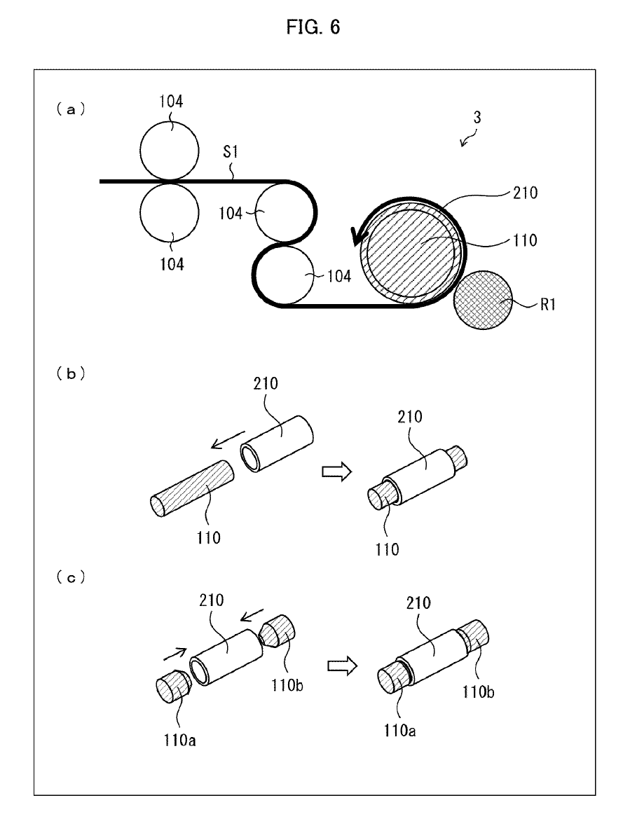

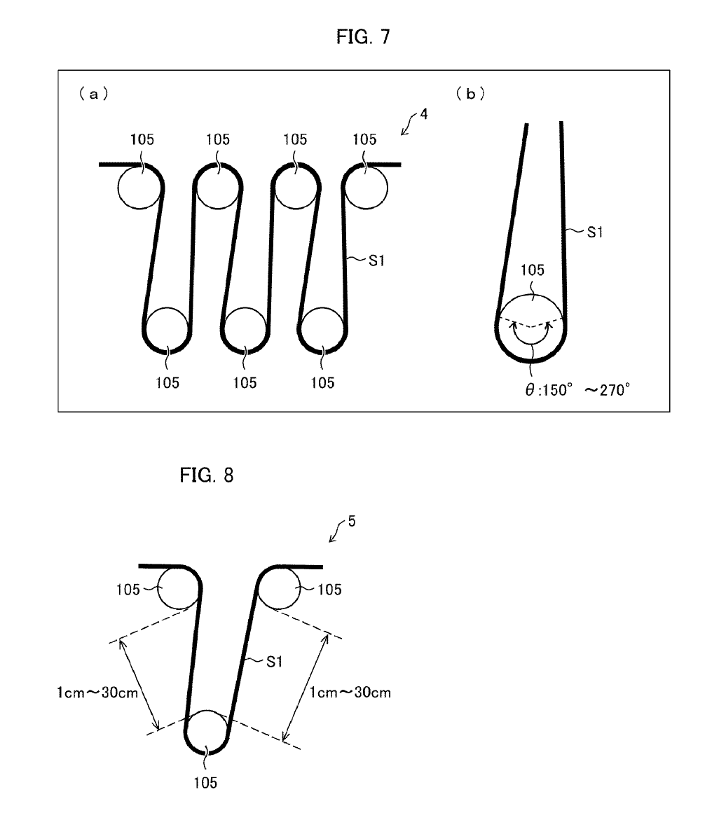

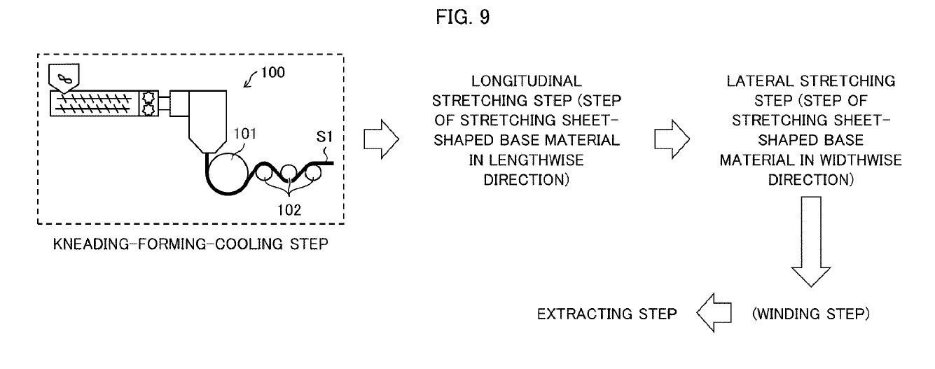

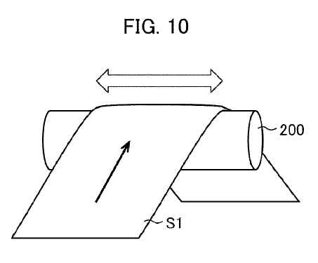

The following description will discuss Embodiment 4 of the present invention with reference to FIG. 6. The present embodiment described here differs from Embodiments 1 and 2 in that the present embodiment includes a conveyer device 3 used during a winding step of winding up a sheet-shaped base material S1. The present embodiment is otherwise as described for Embodiments 1 and 2. A member of the present embodiment that is identical in function to a member illustrated in the drawings referred to for Embodiment 1 or 2 is assigned the same reference sign and is not described again for convenience.

(a) of FIG. 6 is a diagram schematically illustrating the configuration of a conveyer device 3 including a roller R1 that is provided with the porous material covering at least a portion of the curved surface of the roller R1 and that is used as a touch roller for a winding section 110 configured to wind up a sheet-shaped base material S1.

(b) of FIG. 6 is a diagram illustrating a winding section 110 as a winding shaft fit into a core 210. (c) of FIG. 6 is a diagram illustrating a winding section including a core 210 and chucks 110a and 110b each having an inclined surface and sandwiching the core 210.

As illustrated in (a) of FIG. 6, the roller R1 as a touch roller for the winding section 110 to which the core 210 has been attached is provided with the porous material covering at least a portion of the curved surface of the roller R1, and conveyance rollers 104 and the core 210 fit around the winding section 110 each have a curved surface that is smooth and that is not provided with the porous material.

The winding section 110 to which the core 210 has been attached as illustrated in (a) of FIG. 6 may be prepared by, for example, a method of fitting a winding section 110 into a core 210 as illustrated in (b) of FIG. 6 or a method of sandwiching a core 210 with chucks 110a and 110b each having an inclined surface. The method is, however, not limited to these methods.

As illustrated in (a) of FIG. 6, the winding section 110 to which the core 210 has been attached and the roller R1 are arranged such that a sheet-shaped base material S1 comes into contact with the curved surface of the roller R1. Arranging the winding section 110 to which the core 210 has been attached and the roller R1 as such makes it possible to squeeze the fluid plasticizer component from the sheet-shaped base material S1 wound around the core 210.

Using the roller R1 as a touch roller for the winding section 110 for winding up the sheet-shaped base material S1 as described above can prevent the sheet-shaped base material S1 from slipping on that portion of the sheet-shaped base material S1 which has been wound around the core 210 attached to the winding section 110. The above configuration can, in other words, prevent the sheet-shaped base material S1 from (i) slipping in the widthwise direction of that portion of the sheet-shaped base material S1 which has been wound around the core 210 and (ii) meandering in consequence. The above configuration can thereby prevent a defect such as a wrinkle in the sheet-shaped base material S1. The above configuration can also prevent the sheet-shaped base material S1 from slipping on the core 210 when the core 210 starts to wind up the sheet-shaped base material S1. The present embodiment may include a removing mechanism configured to remove the fluid plasticizer adhering to the roller R1.

### Embodiment 5

The following description will discuss Embodiment 5 of the present invention with reference to FIG. 7. The present embodiment described here differs from Embodiments 1 to 4 in that the present embodiment includes a conveyer device 4 including a plurality of conveyance rollers 105 at least one of which has a holding angle of not less than 150 degrees and not more than 270 degrees with respect to the sheet-shaped base material S1. The present embodiment is otherwise as described for Embodiments 1 to 4. A member of the present embodiment that is identical in function to a member illustrated in the drawings referred to for any of Embodiments 1 to 4 is assigned the same reference sign and is not described again for convenience.

(a) of FIG. 7 is a diagram schematically illustrating the configuration of a conveyer device 4 including a plurality of conveyance rollers 105 each having a smooth curved surface that is not provided with the porous material, at least one of the conveyance rollers 105 having a holding angle of not less than 150 degrees and not more than 270 degrees with respect to the sheet-shaped base material S1. (b) of FIG. 7 is a diagram illustrating a conveyance roller 105 having a holding angle of not less than 150 degrees and not more than 270 degrees with respect to the sheet-shaped base material S1.

As illustrated in FIG. 7, the conveyance rollers 105 each have a smooth curved surface that is not provided with the porous material.

Arranging a plurality of such conveyance rollers 105 such that at least one of the conveyance rollers 105 has a holding angle of not less than 150 degrees and not more than 270 degrees with respect to the sheet-shaped base material S1 can prevent the sheet-shaped base material S1 from slipping on the rollers 105. The above configuration can, in other words, prevent the sheet-shaped base material S1 from slipping or meandering in the lengthwise direction of the rollers 105, and can thereby prevent a defect such as a wrinkle in the sheet-shaped base material S1. The above configuration can prevent the sheet-shaped base material S1 from slipping in the conveyance direction, and thus allows the sheet-shaped base material S1 to be conveyed while a sufficient tension is being applied to the sheet-shaped base material S1.

The arrangement of the conveyance rollers 105 for the present embodiment may be applied to any of Embodiments 1 to 4 described above.

The conveyer device 4 is usable suitably during the step of cleaning a sheet-shaped base material S1 for removal of a fluid plasticizer from the sheet-shaped base material S1 (that is, a step of extracting a fluid plasticizer). The conveyer device 4 is, however, not necessarily used during the above step, and may be used during, for example, the kneading-forming-cooling step or stretching step.

The present embodiment is configured such that the slipping preventing mechanism for preventing the sheet-shaped base material S1 from slipping on the conveyance rollers 105 is the arrangement of the plurality of conveyance rollers 105 such that at least one of the conveyance rollers 105 has a holding angle of not less than 150 degrees and not more than 270 degrees with respect to the sheet-shaped base material S1. The present embodiment may include a removing mechanism configured to remove the fluid plasticizer adhering to at least one of the plurality of conveyance rollers 105.

### Embodiment 6

The following description will discuss Embodiment 6 of the present invention with reference to FIG. 8. The present embodiment described here differs from Embodiments 1 to 5 in that the present embodiment includes a conveyer device 5 including conveyance rollers 105 arranged such that the shortest distance between the curved surface of a conveyance roller 105 and the curved surface of an adjacent conveyance roller 105 is not less than 1 cm and not more than 30 cm. The present embodiment is otherwise as described for Embodiments 1 to 5. A member of the present embodiment that is identical in function to a member illustrated in the drawings referred to for any of Embodiments 1 to 5 is assigned the same reference sign and is not described again for convenience.

FIG. 8 is a diagram schematically illustrating the configuration of a conveyer device 5 including a plurality of conveyance rollers 105 each having a smooth curved surface that is not provided with the porous material, the shortest distance between the curved surface of a conveyance roller 105 and the curved surface of an adjacent conveyance roller 105 being not less than 1 cm and not more than 30 cm.

As illustrated in FIG. 8, the conveyance rollers 105 each have a smooth curved surface that is not provided with the porous material.

Arranging a plurality of such conveyance rollers 105 such that the shortest distance between the curved surface of a conveyance roller 105 and the curved surface of an adjacent conveyance roller 105 is not less than 1 cm and not more than 30 cm can prevent the sheet-shaped base material S1 from slipping on the rollers 105. The above configuration can, in other words, prevent the sheet-shaped base material S1 from slipping or meandering in the lengthwise direction of the rollers 105, and can thereby prevent a defect such as a wrinkle in the sheet-shaped base material S1. The above configuration can prevent the sheet-shaped base material S1 from slipping in the conveyance direction, and thus allows the sheet-shaped base material S1 to be conveyed while a sufficient tension is being applied to the sheet-shaped base material S1.

The arrangement of the conveyance rollers 105 for the present embodiment may be applied to any of Embodiments 1 to 5 described above.

The conveyer device 5 is usable suitably during the step of cleaning a sheet-shaped base material S1 for removal of a fluid plasticizer from the sheet-shaped base material S1 (that is, a step of extracting a fluid plasticizer). The conveyer device 5 is, however, not necessarily used during the above step, and may be used during, for example, the kneading-forming-cooling step, stretching step, or winding step.

The present embodiment is configured such that the slipping preventing mechanism for preventing the sheet-shaped base material S1 from slipping on the conveyance rollers 105 is the arrangement of the plurality of conveyance rollers 105 such that the shortest distance between the curved surface of a conveyance roller 105 and the curved surface of an adjacent conveyance roller 105 is not less than 1 cm and not more than 30 cm. The present embodiment may include a removing mechanism configured to remove the fluid plasticizer adhering to at least one of the plurality of conveyance rollers 105.

[Recap]

A conveyer device in accordance with a first aspect of the present invention is a conveyer device, comprising: a plurality of rollers configured to convey a film comprising a fluid plasticizer, the film extending in a longitudinal direction and having a width defined in a direction orthogonal to the longitudinal direction, at least one roller of the plurality of rollers having a length not smaller than the width of the film, the plurality of rollers having a slipping preventing mechanism configured to prevent the film from slipping on the at least one roller.

The above configuration allows the conveyer device to prevent a film comprising a fluid plasticizer from slipping on a roller and thereby prevent a flaw in, for example, the conveyance of the film.

A conveyer device in accordance with a second aspect of the present invention is configured as in the first aspect and may further be configured such that the slipping preventing mechanism includes a porous material on at least a portion of a curved surface of the at least one roller.

With the above configuration, the slipping preventing mechanism includes a porous material on at least a portion of a curved surface of the at least one roller. This allows the conveyer device to prevent a film comprising a fluid plasticizer from slipping on a roller and thereby prevent a flaw in, for example, the conveyance of the film.

A conveyer device in accordance with a third aspect of the present invention is configured as in the second aspect and may further be configured such that the porous material is one selected from the group consisting of rigid urethane, flexible urethane, urethane rubber, urethane elastomer, ethylene propylene rubber, and ethylene-propylene-diene rubber.

The above configuration allows the conveyer device to include a porous material having any of various properties.

A conveyer device in accordance with an fourth aspect of the present invention is configured as in the second aspect and may preferably further be configured such that the porous material has a thickness of not less than 5 mm and not more than 1 cm.

The above configuration allows the conveyer device to include a porous material having an appropriate thickness.

A conveyer device in accordance with a fifth aspect of the present invention is configured as in the second aspect and may further include a contact member provided in contact with the porous material or provided so that the porous material and the contact member sandwich the film.

The above configuration makes it possible to use the contact member to reduce the amount of the fluid plasticizer contained in the porous material.

A conveyer device in accordance with an sixth aspect of the present invention is configured as in the fifth aspect and may further be configured such that the contact member is at least one other roller among the plurality of rollers that is not provided with the porous material or at least one other roller among the plurality of rollers that is provided with the porous material.

The above configuration makes it possible to use at least one other roller among the plurality of rollers that is not provided with the porous material or at least one other roller among the plurality of rollers that is provided with the porous material to reduce the amount of the fluid plasticizer contained in the porous material.

A conveyer device in accordance with a seventh aspect of the present invention is configured as in the fifth aspect and may preferably further be configured such that the at least one roller is configured to be driven to rotate.

The above configuration allows the conveyer device to cause the at least one roller to rotate without a difficulty even in a case where the conveyer device includes the contact member.

A conveyer device in accordance with a eighth aspect of the present invention is configured as in the first aspect and may further be configured such that the slipping preventing mechanism includes asperities on at least a portion of a curved surface of the at least one roller.

With the above configuration, the slipping preventing mechanism includes asperities on at least a portion of a curved surface of the at least one roller. This allows the conveyer device to prevent a film comprising a fluid plasticizer from slipping on a roller and thereby prevent a flaw in, for example, the conveyance of the film.

A conveyer device in accordance with a ninth aspect of the present invention is configured as in the first aspect and may further be configured such that the slipping preventing mechanism comprises configuring the at least one roller to have a holding angle of not less than 150 degrees and not more than 270 degrees with respect to the film.

With the above configuration, the slipping preventing mechanism comprises configuring the at least one roller to have a holding angle of not less than 150 degrees and not more than 270 degrees with respect to the film. This allows the conveyer device to prevent a film comprising a fluid plasticizer from slipping on a roller and thereby prevent a flaw in, for example, the conveyance of the film.

A conveyer device in accordance with a tenth aspect of the present invention is configured as in the first aspect and may further be configured such that the slipping preventing mechanism comprises configuring the plurality of rollers to have a shortest distance of not less than 1 cm and not more than 30 cm between respective curved surfaces of two adjacent rollers among the plurality of rollers.

With the above configuration, the slipping preventing mechanism comprises configuring the plurality of rollers to have a shortest distance of not less than 1 cm and not more than 30 cm between respective curved surfaces of two adjacent rollers among the plurality of rollers. This allows the conveyer device to prevent a film comprising a fluid plasticizer from slipping on a roller and thereby prevent a flaw in, for example, the conveyance of the film.

A conveyer device in accordance with a eleventh aspect of the present invention is configured as in the first aspect and may further be configured such that the at least one roller is of a type selected from the group consisting of (i) a stretching roller configured to stretch the film, (ii) a touch roller configured to come into contact with the film, and (iii) a nip roller configured to hold and convey the film.

The above configuration allows the conveyer device to prevent a film comprising a fluid plasticizer from slipping on a roller and thereby prevent a flaw such as a wrinkle in the film even in a case where the conveyer device includes any of various rollers.

A conveyer device in accordance with a twelfth aspect of the present invention is configured as in the first aspect and may further include a removing mechanism configured to remove, from the at least one roller, an amount of the fluid plasticizer which has adhered to the at least one roller.

The above configuration makes it possible to, with use of the removing mechanism, reduce an amount of the fluid plasticizer which has adhered to the at least one roller.

A method in accordance with a thirteenth aspect of the present invention for producing a film is a method for producing a film, the method comprising: a step of conveying, with use of a plurality of rollers, a film comprising a fluid plasticizer, the film extending in a longitudinal direction and having a width defined in a direction orthogonal to the longitudinal direction, at least one roller of the plurality of rollers having a length not smaller than the width of the film, and the plurality of rollers having a slipping preventing mechanism configured to prevent the film from slipping on the at least one roller.

The above method makes it possible to prevent a film comprising a fluid plasticizer from slipping on a roller and thereby prevent a flaw in, for example, the conveyance of the film.

A method in accordance with a fourteenth aspect of the present invention for producing a film is configured as in the thirteenth aspect and may further be configured such that the conveying step involves causing the film to be in contact with a porous material on at least a portion of a curved surface of the at least one roller while the film is being conveyed.

The above method makes it possible to prevent a film comprising a fluid plasticizer from slipping on a roller and thereby prevent a flaw in, for example, the conveyance of the film.

A method in accordance with an fifteenth aspect of the present invention for producing a film is configured as in the fourteenth aspect and may further be configured such that the conveying step involves reducing an amount of the fluid plasticizer with use of a contact member provided in contact with the porous material or provided so that the porous material and the contact member sandwich the film.

The above method for producing a film makes it possible to use the contact member to reduce the amount of the fluid plasticizer contained in the porous material.

A method in accordance with a sixteenth aspect of the present invention for producing a film is configured as in the fifteenth aspect and may further be configured such that the contact member is at least one other roller among the plurality of rollers that is not provided with the porous material or at least one other roller among the plurality of rollers that is provided with the porous material.

The above method for producing a film makes it possible to use at least one other roller among the plurality of rollers that is not provided with the porous material or at least one other roller among the plurality of rollers that is provided with the porous material to reduce the amount of the fluid plasticizer contained in the porous material.

A method in accordance with a seventeenth aspect of the present invention for producing a film is configured as in the fifteenth aspect and may further be configured such that the conveying step involves driving the at least one roller to rotate.

The above method for producing a film causes the at least one roller to rotate without a difficulty even in a case where the conveyer device includes the contact member.

A method in accordance with a eighteenth aspect of the present invention for producing a film is configured as in the thirteenth aspect and may further be configured such that the conveying step involves causing the film to be in contact with asperities on at least a portion of a curved surface of the at least one roller while the film is being conveyed.

The above method makes it possible to prevent a film comprising a fluid plasticizer from slipping on a roller and thereby prevent a flaw in, for example, the conveyance of the film.

A method in accordance with a nineteenth aspect of the present invention for producing a film is configured as in the thirteenth aspect and may further be configured such that the slipping preventing mechanism comprises configuring the at least one roller to have a holding angle of not less than 150 degrees and not more than 270 degrees with respect to the film.

The above method makes it possible to prevent a film comprising a fluid plasticizer from slipping on a roller and thereby prevent a flaw in, for example, the conveyance of the film.

A method in accordance with a twentieth aspect of the present invention for producing a film is configured as in the thirteenth aspect and may further be configured such that the slipping preventing mechanism comprises configuring the plurality of rollers to have a shortest distance of not less than 1 cm and not more than 30 cm between respective curved surfaces of two adjacent rollers among the plurality of rollers.

The above method makes it possible to prevent a film comprising a fluid plasticizer from slipping on a roller and thereby prevent a flaw in, for example, the conveyance of the film.

A method in accordance with a twenty-first aspect of the present invention for producing a film is configured as in the thirteenth aspect and may further be configured such that the conveying step is included in (i) a step of cooling the film, (ii) a step of stretching the film in the longitudinal direction of the film, (iii) a step of stretching the film in the direction orthogonal to the longitudinal direction, (iv) a step of winding up the film, or (v) a step of cleaning the film for removal of an amount of the fluid plasticizer from the film.

The above method makes it possible to prevent a film comprising a fluid plasticizer from slipping on a roller and thereby prevent a flaw in, for example, the conveyance of the film in (i) a step of cooling the film, (ii) a step of stretching the film in the longitudinal direction of the film, (iii) a step of stretching the film in the direction orthogonal to the longitudinal direction, (iv) a step of winding up the film, or (v) a step of cleaning the film for removal of an amount of the fluid plasticizer from the film.

A conveyer device in accordance with a twenty-second aspect of the present invention is a conveyer device, including: a plurality of rollers configured to convey a film containing a fluid plasticizer, at least one of the plurality of rollers having a length not smaller than a width of the film which width is in a direction orthogonal to a longitudinal direction of the film and being provided with a slipping preventing mechanism configured to prevent the film from slipping on the at least one of the plurality of rollers.

The above configuration allows the conveyer device to prevent a film containing a fluid plasticizer from slipping on a roller and thereby prevent a flaw in, for example, the conveyance of the film.

A conveyer device in accordance with a twenty-third aspect of the present invention is configured as in the twenty-second aspect and may further be configured such that the slipping preventing mechanism includes a porous material on at least a portion of a curved surface of the at least one of the plurality of rollers.

With the above configuration, the slipping preventing mechanism includes a porous material on at least a portion of a curved surface of the at least one of the plurality of rollers. This allows the conveyer device to prevent a film containing a fluid plasticizer from slipping on a roller and thereby prevent a flaw in, for example, the conveyance of the film.

A conveyer device in accordance with a twenty-fourth aspect of the present invention is configured as in the twenty-second aspect and may further be configured such that the slipping preventing mechanism includes asperities on at least a portion of a curved surface of the at least one of the plurality of rollers.

With the above configuration, the slipping preventing mechanism includes asperities on at least a portion of a curved surface of the at least one of the plurality of rollers. This allows the conveyer device to prevent a film containing a fluid plasticizer from slipping on a roller and thereby prevent a flaw in, for example, the conveyance of the film.

A conveyer device in accordance with a twenty-fifth aspect of the present invention is configured as in any of the twenty-second to twenty-fourth aspects and may further be configured such that the slipping preventing mechanism includes a roller having a holding angle of not less than 150 degrees and not more than 270 degrees with respect to the film.

With the above configuration, the slipping preventing mechanism includes a roller having a holding angle of not less than 150 degrees and not more than 270 degrees with respect to the film. This allows the conveyer device to prevent a film containing a fluid plasticizer from slipping on a roller and thereby prevent a flaw in, for example, the conveyance of the film.

A conveyer device in accordance with a twenty-sixth aspect of the present invention is configured as in any of the twenty-second to twenty-fifth aspects and may further be configured such that the slipping preventing mechanism is a shortest distance of not less than 1 cm and not more than 30 cm between respective curved surfaces of two adjacent rollers among the plurality of rollers.

With the above configuration, the slipping preventing mechanism is a shortest distance of not less than 1 cm and not more than 30 cm between respective curved surfaces of two adjacent rollers among the plurality of rollers. This allows the conveyer device to prevent a film containing a fluid plasticizer from slipping on a roller and thereby prevent a flaw in, for example, the conveyance of the film.

A conveyer device in accordance with a twenty-seventh aspect of the present invention is configured as in any of the twenty-second to twenty-sixth aspects and may further be configured such that the at least one of the plurality of rollers includes at least one kind selected from (i) a stretching roller configured to stretch the film, (ii) a touch roller configured to come into contact with the film, and (iii) a nip roller configured to hold and convey the film.

The above configuration allows the conveyer device to prevent a film containing a fluid plasticizer from slipping on a roller and thereby prevent a flaw such as a wrinkle in the film even in a case where the conveyer device includes any of various rollers.

A conveyer device in accordance with a twenty-eighth aspect of the present invention is configured as in the twenty-third aspect and may further be configured such that the porous material is one selected from the group consisting of rigid urethane, flexible urethane, urethane rubber, urethane elastomer, ethylene propylene rubber, and ethylene-propylene-diene rubber.

The above configuration allows the conveyer device to include a porous material having any of various properties.

A conveyer device in accordance with a twenty-ninth aspect of the present invention is configured as in any of the twenty-second to twenty-eighth aspects and may preferably further be configured such that the porous material has a thickness of not less than 5 mm and not more than 1 cm.

The above configuration allows the conveyer device to include a porous material having an appropriate thickness.

A conveyer device in accordance with a thirtieth aspect of the present invention is configured as in any of the twenty-second to twenty-ninth aspects and may further include a removing mechanism configured to remove, from the at least one of the plurality of rollers, the fluid plasticizer adhering to the at least one of the plurality of rollers.

The above configuration makes it possible to, with use of the removing mechanism, reduce the fluid plasticizer adhering to the at least one of the plurality of rollers.

A conveyer device in accordance with a thirty-first aspect of the present invention is configured as in any of the twenty-third, twenty-eighth, and twenty-ninth aspects and may further include a contact member provided in contact with the porous material or provided so that the porous material and the contact member sandwich the film.

The above configuration makes it possible to use the contact member to reduce the amount of the fluid plasticizer contained in the porous material.

A conveyer device in accordance with a thirty-second aspect of the present invention is configured as in the thirty-first aspect and may further be configured such that the contact member is a roller among the plurality of rollers that is not provided with the porous material or a roller among the plurality of rollers that is provided with the porous material.

The above configuration makes it possible to use a roller not provided with the porous material or a roller provided with the porous material to reduce the amount of the fluid plasticizer contained in the porous material.

A conveyer device in accordance with a thirty-third aspect of the present invention is configured as in the thirty-first or thirty-second aspect and may preferably further be configured such that the at least one of the plurality of rollers is configured to be driven to rotate.

The above configuration allows the conveyer device to cause a roller to rotate without a difficulty even in a case where the conveyer device includes the contact member.

A method in accordance with a thirty-fourth aspect of the present invention for producing a film is a method for producing a film, the method including the step of: conveying, with use of a plurality of rollers, a film containing a fluid plasticizer, at least one of the plurality of rollers having a length not smaller than a width of the film which width is in a direction orthogonal to a longitudinal direction of the film and being provided with a slipping preventing mechanism configured to prevent the film from slipping on the at least one of the plurality of rollers.

The above method makes it possible to prevent a film containing a fluid plasticizer from slipping on a roller and thereby prevent a flaw in, for example, the conveyance of the film.

A method in accordance with a thirty-fifth aspect of the present invention for producing a film is configured as in the thirty-fourth aspect and may further be configured such that the conveying step involves causing the film to be in contact with a porous material on at least a portion of a curved surface of the at least one of the plurality of rollers while the film is being conveyed.

The above method makes it possible to prevent a film containing a fluid plasticizer from slipping on a roller and thereby prevent a flaw in, for example, the conveyance of the film.

A method in accordance with a thirty-sixth aspect of the present invention for producing a film is configured as in the thirty-fourth aspect and may further be configured such that the conveying step involves causing the film to be in contact with asperities on at least a portion of a curved surface of the at least one of the plurality of rollers while the film is being conveyed.

The above method makes it possible to prevent a film containing a fluid plasticizer from slipping on a roller and thereby prevent a flaw in, for example, the conveyance of the film.

A method in accordance with a thirty-seventh aspect of the present invention for producing a film is configured as in any of the thirty-fourth to thirty-sixth aspects and may further be configured such that the at least one of the plurality of rollers has a holding angle of not less than 150 degrees and not more than 270 degrees with respect to the film.

The above method makes it possible to prevent a film containing a fluid plasticizer from slipping on a roller and thereby prevent a flaw in, for example, the conveyance of the film.

A method in accordance with a thirty-eighth aspect of the present invention for producing a film is configured as in any of the thirty-fourth to thirty-seventh aspects and may further be configured such that a shortest distance is not less than 1 cm and not more than 30 cm between respective curved surfaces of two adjacent rollers among the plurality of rollers.

The above method makes it possible to prevent a film containing a fluid plasticizer from slipping on a roller and thereby prevent a flaw in, for example, the conveyance of the film.

A method in accordance with a thirty-ninth aspect of the present invention for producing a film is configured as in the thirty-fifth aspect and may further be configured such that the conveying step involves reducing an amount of the fluid plasticizer with use of a contact member provided in contact with the porous material or provided so that the porous material and the contact member sandwich the film.

The above method for producing a film makes it possible to use the contact member to reduce the amount of the fluid plasticizer contained in the porous material.

A method in accordance with a fortieth aspect of the present invention for producing a film is configured as in the thirty-ninth aspect and may further be configured such that the contact member is a roller among the plurality of rollers that is not provided with the porous material or a roller among the plurality of rollers that is provided with the porous material.

The above method for producing a film makes it possible to use a roller not provided with the porous material or a roller provided with the porous material to reduce the amount of the fluid plasticizer contained in the porous material.

A method in accordance with a forty-first aspect of the present invention for producing a film is configured as in the thirty-ninth or fortieth aspect and may further be configured such that the conveying step involves driving the at least one of the plurality of rollers to rotate.

The above method for producing a film causes a roller to rotate without a difficulty even in a case where the conveyer device includes the contact member.

A method in accordance with a forty-second aspect of the present invention for producing a film is configured as in any of the thirty-fourth to forty-first aspects and may further be configured such that the conveying step is included in (i) a step of cooling the film, (ii) a step of stretching the film in a longitudinal direction of the film, (iii) a step of stretching the film in a direction orthogonal to the longitudinal direction, (iv) a step of winding up the film, or (v) a step of cleaning the film for removal of the fluid plasticizer from the film.

The above method makes it possible to prevent a film containing a fluid plasticizer from slipping on a roller and thereby prevent a flaw in, for example, the conveyance of the film in (i) a step of cooling the film, (ii) a step of stretching the film in a longitudinal direction of the film, (iii) a step of stretching the film in a direction orthogonal to the longitudinal direction, (iv) a step of winding up the film, or (v) a step of cleaning the film for removal of the fluid plasticizer from the film.

[Supplemental Notes]

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### INDUSTRIAL APPLICABILITY

The present invention is applicable to a conveyer device and a method for producing a film.

### REFERENCE SIGNS LIST

1 Conveyer device

2 Conveyer device

3 Conveyer device

4 Conveyer device

5 Conveyer device

100 Twin-screw extruder

102 Conveyance roller

103 Stretching roller

104 Conveyance roller

105 Conveyance roller

110 Winding section

110a Chuck with an inclined surface

110b Chuck with an inclined surface

210 Core

R1 Roller

R2 Squeeze roller

R3 Nip roller

R4 Nip roller

R6 Roller

S1 Sheet-shaped base material containing a fluid plasticizer

1. A conveyer device comprising:
a plurality of rollers configured to convey a film comprising a fluid plasticizer, the film extending in a longitudinal direction and having a width defined in a direction orthogonal to the longitudinal direction,
at least one roller of the plurality of rollers having a length not smaller than the width of the film, the plurality of rollers having a slipping preventing mechanism configured to prevent the film from slipping on the at least one roller.

2. The conveyer device according to claim 1,
wherein
the slipping preventing mechanism includes a porous material on at least a portion of a curved surface of the at least one roller.

3. The conveyer device according to claim 2,
wherein
the porous material is one selected from the group consisting of rigid urethane, flexible urethane, urethane rubber, urethane elastomer, ethylene propylene rubber, and ethylene-propylene-diene rubber.

4. The conveyer device according to claim 2,
wherein the porous material has a thickness of not less than 5 mm and not more than 1 cm.

5. The conveyer device according to claim 2, further comprising:
a contact member provided in contact with the porous material or provided so that the porous material and the contact member sandwich the film.

6. The conveyer device according to claim 5,
wherein the contact member is at least one other roller among the plurality of rollers that is not provided with the porous material or at least one other roller among the plurality of rollers that is provided with the porous material.

7. The conveyer device according to claim 5,
wherein the at least one roller is configured to be driven to rotate.

8. The conveyer device according to claim 1,
wherein
the slipping preventing mechanism includes asperities on at least a portion of a curved surface of the at least one roller.

9. The conveyer device according to claim 1,
wherein
the slipping preventing mechanism comprises configuring the at least one roller to have a holding angle of not less than 150 degrees and not more than 270 degrees with respect to the film.

10. The conveyer device according to claim 1,
wherein
the slipping preventing mechanism comprises configuring the plurality of rollers to have a shortest distance of not less than 1 cm and not more than 30 cm between respective curved surfaces of two adjacent rollers among the plurality of rollers.

11. The conveyer device according to claim 1,
wherein
the at least one roller is of a type selected from the group consisting of (i) a stretching roller configured to stretch the film, (ii) a touch roller configured to come into contact with the film, and (iii) a nip roller configured to hold and convey the film.

12. The conveyer device according to claim 1, further comprising:
a removing mechanism configured to remove, from the at least one roller, an amount of the fluid plasticizer which has adhered to the at least one roller.

13. A method for producing a film, the method comprising:
a step of conveying, with use of a plurality of rollers, a film comprising a fluid plasticizer,
the film extending in a longitudinal direction and having a width defined in a direction orthogonal to the longitudinal direction, at least one roller of the plurality of rollers having a length not smaller than the width of the film, and the plurality of rollers having a slipping preventing mechanism configured to prevent the film from slipping on the at least one roller.

14. The method according to claim 13,
wherein
the conveying step involves causing the film to be in contact with a porous material on at least a portion of a curved surface of the at least one roller while the film is being conveyed.

15. The method according to claim 14,
wherein
the conveying step involves reducing an amount of the fluid plasticizer with use of a contact member provided in contact with the porous material or provided so that the porous material and the contact member sandwich the film.

16. The method according to claim 15,
wherein
the contact member is at least one other roller among the plurality of rollers that is not provided with the porous material or at least one other roller among the plurality of rollers that is provided with the porous material.

17. The method according to claim 15,
wherein
the conveying step involves driving the at least one roller to rotate.

18. The method according to claim 13,
wherein
the conveying step involves causing the film to be in contact with asperities on at least a portion of a curved surface of the at least one roller while the film is being conveyed.

19. The method according to claim 13,
wherein the slipping preventing mechanism comprises configuring the at least one roller to have a holding angle of not less than 150 degrees and not more than 270 degrees with respect to the film.

20. The method according to claim 13,
wherein the slipping preventing mechanism comprises configuring the plurality of rollers to have a shortest distance of not less than 1 cm and not more than 30 cm between respective curved surfaces of two adjacent rollers among the plurality of rollers.

21. The method according to claim 13,
wherein
the conveying step is included in (i) a step of cooling the film, (ii) a step of stretching the film in the longitudinal direction of the film, (iii) a step of stretching the film in the direction orthogonal to the longitudinal direction, (iv) a step of winding up the film, or (v) a step of cleaning the film for removal of an amount of the fluid plasticizer from the film.
